(19) United States
(12) Patent Application Publication
(10) Pub. No.: US 2015/0245601 A1
(43) Pub. Date: Sep. 3, 2015

(54) LIGHTNING STRIKE FISHING POLE HOOK SETTER

(71) Applicant: Mark A. HERZOG, Columbia Falls, MT (US)

(72) Inventor: Mark A. HERZOG, Columbia Falls, MT (US)

(21) Appl. No.: 14/634,267

(22) Filed: Feb. 27, 2015

Related U.S. Application Data
(60) Provisional application No. 61/946,211, filed on Feb. 28, 2014.

(51) Int. Cl. A01K 97/11; A01K 97/12

(52) U.S. Cl. CPC A01K 97/11; A01K 97/12

(57) ABSTRACT

Disclosed embodiments include a hook setting apparatus having a base, a rod holder block rotatable about a shaft in communication with the base, a rod holder tube connected to the rod holder block, a trigger rod movably mounted in the base and connected to the rod holder block, and selectively contactable with a trigger block, a trigger trip rod connected to the trigger block, and movement of the trigger trip rod imparts motion to the trigger block and releases the selective contact between the trigger block and the trigger rod and causes the rod holder block to rotate about the shaft.

### CROSS-REFENENCE TO RELATED APPLICATIONS

This application, under 35 U.S.C. §119, claims the benefit of U.S. Provisional Patent Application Ser. No. 61/946,211 filed on Feb. 28, 2014, and entitled “Lightning Strike Fishing Pole,” the contents of which are hereby incorporated by reference herein.

### FIELD OF THE DISCLOSURE

This disclosure related to apparatus for fishing. More particularly, the disclosure relates to apparatus for automatically setting a hook when a fish strikes the same.

### BACKGROUND

Some automatic fishing apparatus already exist, however, they are often inconvenient to use because they are not adjustable in one or more aspects concerning the type of fishing rod they can hold, the setting force of the hook, the amount of force that will trigger the setting of the hook, or the size and position of the support used. The inability to adjust one or more of these aspects of existing devices can be inconvenient and cause misfires, lost fish, or other undesirable results. Other drawbacks and disadvantages of existing apparatus may also exist.

Accordingly, there is a need for an adjustable hook setting apparatus that is easy to set and reliable to use. In particular, there is a need for an automatic hook setting apparatus that is adaptable to a variety of fishing conditions, types of fish, types of fishing rods, or the like. Other needs may also exist.

### SUMMARY

Accordingly, the present disclosure provides apparatus that ameliorates the drawbacks and disadvantages of existing apparatus and substantially meets the existing needs identified above.

In some disclosed embodiments there is provided a hook setting apparatus comprising a base, a rod holder block rotatable about a shaft in communication with the base, a rod holder tube connected to the rod holder block, a trigger rod movably mounted in the base and connected to the rod holder block, and selectively contactable with a trigger block, a trigger trip rod connected to the trigger block, and wherein movement of the trigger trip rod imparts motion to the trigger block and releases the selective contact between the trigger block and the trigger rod and causes the rod holder block to rotate about the shaft.

In some disclosed embodiments the trigger rod includes a biasing spring that exerts a biasing force on the trigger rod and imparts motion to the trigger rod when the selective contact between the trigger block and the trigger rod is released. In further embodiments, the biasing force is adjustable.

In some embodiments, the hooks setting apparatus further comprises a trigger block spring in contact with the trigger block and wherein the trigger block spring exerts a biasing force on the trigger block. In further embodiments, the biasing force is adjustable.

In some embodiments, the hook setting apparatus further comprises a sear plate connected to the trigger block. In further embodiments, the sear plate selectively contacts the trigger rod. In still further embodiments, the amount of the sear plate that selectively contacts the trigger rod is adjustable.

In some embodiments, the trigger trip rod is adjustable. In further embodiments, the trigger trip rod is adjustable in length.

In some embodiments, the rod holder tube is removable from the rod holder block. In further embodiments, of the hook setting apparatus a second rod holder tube that is selectively attachable to the rod holder block.

In some embodiments of the hook setting apparatus at least one leg is connected to the base. In further embodiments, the at least one leg is adjustable. Other embodiments, advantages, and features of the disclosed apparatus also exist and will be apparent from the below detailed description.

### BRIEF DESCRIPTION OF THE DRAWINGS

FIG. 1 is a perspective view of hook setting apparatus in the closed or transportable position in accordance with some disclosed embodiments.

FIG. 2 is a perspective view of hook setting apparatus with a fishing rod mounted in the set position in accordance with some disclosed embodiments.

FIG. 3 is a cross-sectional view of hook setting apparatus with a fishing rod mounted in the set position in accordance with some disclosed embodiments.

FIG. 4 is cross-sectional view of hook setting apparatus with a fishing rod in the triggered position in accordance with some disclosed embodiments.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

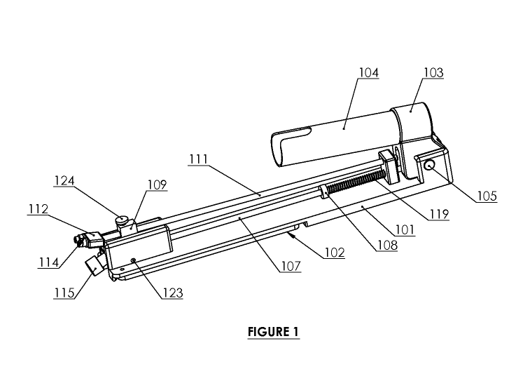

FIG. 1 is a perspective view of hook setting apparatus in the closed or transportable position in accordance with some disclosed embodiments. As shown, embodiments of the hook setting apparatus may include a base 101 to rigidly and securely mount the other components. Base 101 may comprise any suitable material sufficient to securely mount the other components. For example, base 101 may comprise metal, metal-alloys, plastics, fiberglass, wood, composite materials, or combinations of the foregoing.

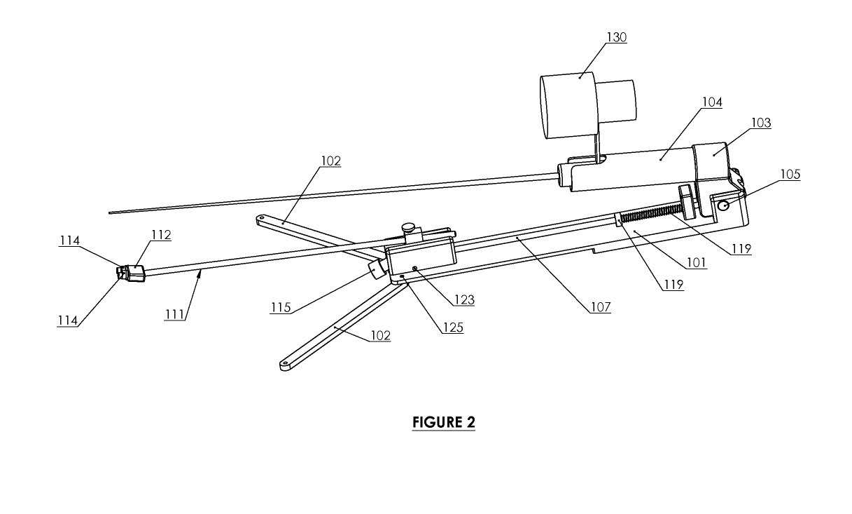

As shown, embodiments of the hook setting apparatus may also include one or more legs 102. As shown in FIGS. 1-2, legs 102 may be positionable to enhance the stability of the apparatus, to accommodate a varying surface where the device is set, and to facilitate transport and storage. For example, legs 102 may pivot about pivot screws 125 in order to fold out of the way during storage and transport (FIG. 1) or be spread apart to offer greater stability when the apparatus is in use (FIG. 2). Other types of positionable legs are also possible.

Some embodiments of hook setting apparatus may also comprise a rod holder block 103. Rod holder block 103 is configured to connect to or otherwise hold a rod holder tube 104. For example, rod holder tube 104 may thread into corresponding threads in rod holder block 103. Other arrangements are also possible, and in some embodiments rod holder block 103 and rod holder tube 104 may be integrally formed.

For embodiments where rod holder block 103 and rod holder tube are separate pieces, it may be advantageous to provide more than one rod holder tube 104. For example, different sized rod holder tubes 104 may be used to accommodate fishing rods 130 of differing sizes or types.

As shown, rod holder block 103 may be pivotably attached to base 101 via a rod holder shaft 105. As disclosed herein, rod holder block 103 and rod holder tube 104 may pivot about shaft 105 to set the apparatus in a ready position and when triggered to set a hook as described herein.

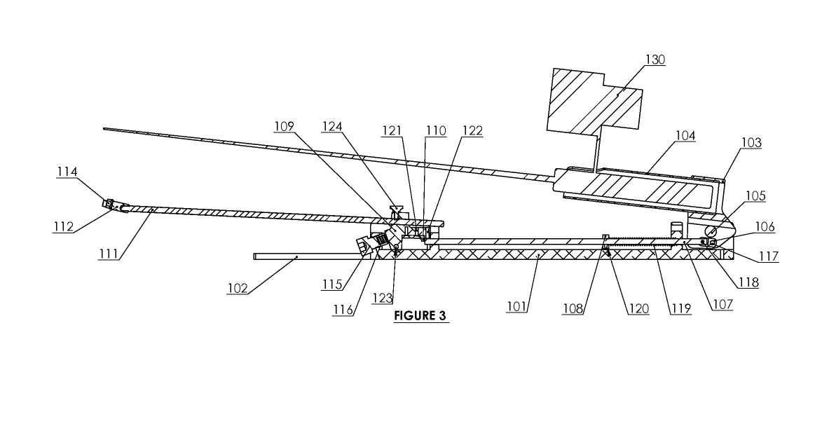

Some embodiments of the hook setting apparatus may also include trigger rod 107. Again, trigger rod 107 may comprise any suitable material such as metals, alloys, plastics, composites, wood, or combinations of the same. As shown in FIG. 3, trigger rod 107 may be connected to rod holder block 103 through, for example, trigger rod link 106 held in place by pins 117, 118, so that when triggered the motion of the trigger rod 107 causes the rotation of the rod holder block 103 and rod holder tube 104 about rod holder shaft 105.

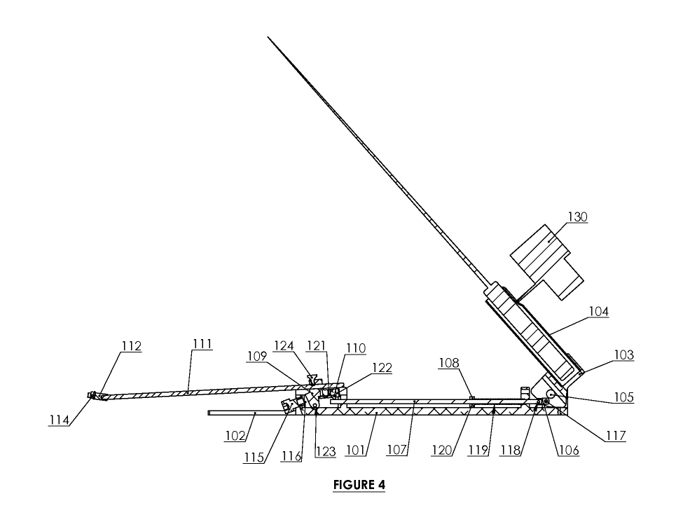

Embodiments of the apparatus may also include a trigger rod collar 108 to enable the adjustment of the force used to rotate the rod holder 103 (and ultimately the force used to set the hook (not shown) of fishing rod 130). Any suitable mechanisms for adjusting the force may be implemented. For example, trigger rod collar 108 may be positionable along the trigger rod 107, for example, by use of a set screw 120 (as shown in FIG. 4) in order to vary the compression/expansion force of an actuator spring 119 mounted in or against a shoulder in base 101. Other mechanisms for adjusting the force used to set the hook are also possible, for example, trigger rod 107 may be threaded and rod collar 108 may have corresponding threads on an interior surface that allow the collar 108 to be positioned along the threading on the rod 107. In this manner, the hook setting apparatus can be fine-tuned in accordance with the type of fish or other fishing conditions.

As perhaps best illustrated in FIGS. 3-4, the setting and triggering of the hook setting apparatus in some embodiments may be enabled by trigger block 109 and trigger block sear plate 110. As shown in FIG. 3, when in the set or ready to use position trigger rod 107 is prevented from moving with the force set in compressed spring actuator 119 by contact with the trigger rod sear plate 110. In some embodiments, trigger rod sear plate 110 is connected to trigger block 109, for example, using screws 121. Of course, other connections are possible, and in some embodiments, the trigger block 109 and sear plate 110 may be integrally formed.

As shown in FIG. 4, when trigger trip rod 111 is moved (e.g., due to the strike of a fish on a hook (not shown) attached to rod 130), trigger block 109 pivots about a pivot pin 123 causing sear plate 110 to move and release trigger rod 107 allowing it to move forward under the force of expanding actuator spring 119. The motion of trigger rod 107, in turn, cause the rotation of rod holder block 103 and rod holder tube 104 (and ultimately sets the hook (not shown) of fishing rod 130) as described previously herein. Other triggering mechanisms are also possible.

As also shown, embodiments of the hook setting apparatus are adjustable with respect to the amount of force required to actuate the trigger mechanisms. For example, trigger block 109 may be biased into position by a biasing device such as block spring 116. Furthermore, the amount of biasing due to block spring 116 may be adjustable using, for example, block spring adjuster 115 to vary the compression/expansion force of block spring 116. For example, in some embodiments block spring adjuster 115 may comprise a threaded knob that contacts or is connected to block spring 116 and can be used to move the spring 116 and adjust the compression/expansion force accordingly. Other adjustment mechanisms are also possible.

In addition, embodiments of the hook setting apparatus may also include the capability to adjust the sear plate 110 and trigger rod 107 interface. For example, a set screw 122 may be used to adjust how much of the sear plate 110 contacts the trigger rod 107. Other adjustment mechanisms are also possible. In this manner, the amount of motion of the trigger trip rod 111 necessary to move the trigger block 109 and sear plate 110 may be fine-tuned as fishing or other conditions require.

As also shown, embodiments of the hook setting apparatus may also include adjustment mechanisms for the trigger trip rod 111. For example, the length of trigger trip rod 111 that extends beyond the front edge of base 101 may be adjusted, for example, by use of a clamp screw 124 that enables trip rod 111 to be releasably held in place at the desired position. In addition to enabling convenient positioning of the trip rod 111, the adjustment of the length of trip rod 111 can also be used to fine-tune the amount of force required to actuate the trigger block 109 mechanism because torque generated about block pivot 123 will vary with the length of trip rod 111. In addition, and as shown in FIG. 1, for some embodiments, trip rod 111 may be positionable within a suitable hole or indent in base 101, or a portion thereof, and secured by clamp screw 124 to facilitate storage and transport of the hook setting apparatus.

As also shown, embodiments of the hook setting apparatus may also include a trip rod end block 112 that is shaped to facilitate positioning and retention of the fishing rod 130 line (not shown). For example, embodiments of the hook setting apparatus may include pins, eyelets, or rollers 114 through which the fishing line (not shown) may be threaded in order to keep it in the desired location.

As should be apparent from the above disclosure, the disclosed embodiments enable an adjustable hook setting apparatus that can be adjusted and set in accordance with fishing or other environmental conditions in order to increase the chances of a successful, automatic setting of a fish hook in the mouth of a fish when the fish strikes the hook, bait, or other lure. In operation, a user may unfold or otherwise position legs 102 to provide a stable support for base 101. A fishing pole 130 may be placed in an appropriate rod holder tube 104. Fishing line and a hook (not shown) may be threaded through rollers 114 in trip rod end block 112 and placed into the water being fished. Trip rod 111 may be adjusted via clamp screw 124 to position the hook in the desired location, or to provide the appropriate triggering force desired to actuate trigger block 109 when a fish strikes the hook. In addition, the amount of force necessary to trigger the hook setting apparatus can be adjusted through block spring adjuster 115 and/or sear plate 110 engagement set screw 122. Likewise, the amount of hook setting force can be adjusted through trigger rod collar 108 and actuator spring 119. The hook setting apparatus is initially set in the ready position shown n FIG. 3, for example, and the trigger mechanisms (e.g., 111, 109, 110, 107) engaged in place. When a fish strikes the hook (not shown) the trigger mechanisms will move and actuate the pivoting of the fishing rod 130 (via block 103 and tube 104) causing the hook to be set in the fish's mouth.

Although various embodiments have been shown and described, the present disclosure is not so limited and will be understood to include all such modifications and variations are would be apparent to one skilled in the art.

What is claimed is:

1. A hook setting apparatus comprising:
a base;
a rod holder block rotatable about a shaft in communication with the base;
a rod holder tube connected to the rod holder block;
a trigger rod movably mounted in the base and connected to the rod holder block, and selectively contactable with a trigger block;
a trigger trip rod connected to the trigger block; and
wherein movement of the trigger trip rod imparts motion to the trigger block and releases the selective contact between the trigger block and the trigger rod and causes the rod holder block to rotate about the shaft.

2. The hook setting apparatus of claim 1 wherein the trigger rod includes a biasing spring that exerts a biasing force on the trigger rod and imparts motion to the trigger rod when the selective contact between the trigger block and the trigger rod is released.

3. The hook setting apparatus of claim 2 wherein the biasing force is adjustable.

4. The hook setting apparatus of claim 1 further comprising a trigger block spring in contact with the trigger block and wherein the trigger block spring exerts a biasing force on the trigger block.

5. The hook setting apparatus of claim 4 wherein the biasing force is adjustable.

6. The hook setting apparatus of claim 1 further comprising a sear plate connected to the trigger block.

7. The hook setting apparatus of claim 6 wherein the sear plate selectively contacts the trigger rod.

8. The hook setting apparatus of claim 7 wherein the amount of the sear plate that selectively contacts the trigger rod is adjustable.

9. The hook setting apparatus of claim 1 wherein the trigger trip rod is adjustable.

10. The hook setting apparatus of claim 9 wherein the trigger trip rod is adjustable in length.

11. The hook setting apparatus of claim 1 wherein the rod holder tube is removable from the rod holder block.

12. The hook setting apparatus of claim 11 further comprising a second rod holder tube that is selectively attachable to the rod holder block.

13. The hook setting apparatus of claim 1 further comprising at least one leg connected to the base.

14. The hook setting apparatus of claim 13 wherein the at least one leg is adjustable.
